(19) United States
(12) Patent Application Publication
(10) Pub. No.: US 2005/0017975 A1
(43) Pub. Date: Jan. 27, 2005

(54) Displaying image data

(76) Inventor: Michael John Russo, San Francisco, CA (US)

Correspondence Address: MOSER, PATTERSON & SHERIDAN, L.L.P., 3040 POST OAK BOULEVARD, SUITE 1500, HOUSTON, TX, 77056, US

(21) Appl. No.: 10/882,954

(22) Filed: Jul. 1, 2004

Related U.S. Application Data
(60) Provisional application No. 60/489,387, filed on Jul. 23, 2003.

(51) Int. Cl. G06T 15/20

(52) U.S. Cl. 345/427

(57) ABSTRACT

A machine-readable definition of a three-dimensional object is represented. A schematic view of the image in which elements of the three-dimensional object are defined by nodes and relationships between said nodes are represented by links is displayed. An image view of three-dimensional object is rendered to produce a two-dimensional view from a specified viewing position. Input data that selects one or more elements shown in the two-dimensional view is received. Nodes and links of the schematic view that correspond to the elements selected by the input data are identified and a topological transformation is performed to produce a modified schematic view. The nodes and links in the modified schematic view are positioned in substantially similar relative positions compared with their respective elements in the image view.

### CROSS-REFERENCE TO RELATED APPLICATIONS

This application claims benefit of U.S. provisional patent application Ser. No. 60/489,387, filed Jul. 23, 2003, which is herein incorporated by reference.

### BACKGROUND OF THE INVENTION

1. Field of the Invention

Embodiments of the present invention generally relate to representing a schematic of a scene including three dimensional objects and the relationships between the objects.

2. Description of the Related Art

The present invention relates to representing a machine-readable definition of a three-dimensional object.

A problem associated with representing three-dimensional data is that a user often encounters difficulties in terms of identifying data of interest. This problem becomes more acute as data sets become larger.

### SUMMARY OF THE INVENTION

The present invention generally facilitates the representation and display of three dimensional object data and relationships between object elements. An image view of a three-dimensional object is rendered to produce a two-dimensional view from a specified viewing position. Input data that selects one or more elements shown in the two-dimensional view is received. Nodes and links of a schematic view of the image that correspond to the elements selected by the input data are identified and a topological transformation is performed to produce a modified schematic view. The nodes and links in the modified schematic view are positioned in substantially similar relative positions compared with their respective elements in the image view.

One embodiment of a system and method for displaying a modified schematic view of a scene including a three dimensional object includes displaying an image view of the scene to produce a two-dimensional view from a specified viewing position, receiving a first selection data input specifying a first element of the three-dimensional object, the first element represented by a first node, topologically transforming the first node to produce a transformed first node, the transformed first node corresponding with a position of the first element in the image view, and displaying the modified schematic view including the transformed first node.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows an environment for representing a machine-readable definition of a three-dimensional object, according to one embodiment of the present invention;

FIG. 2 shows the components of computer system shown in FIG. 1, according to one embodiment of the present invention;

FIG. 3 shows operations performed by the system illustrated in FIG. 2, according to one embodiment of the present invention;

FIG. 4 shows a user interface generated after application loading, according to one embodiment of the present invention;

FIG. 5 shows a detail of part of the user interface shown in FIG. 4, according to one embodiment of the present invention;

FIG. 6 shows a flow chart of steps involved in a preferred embodiment of the invention, according to one embodiment of the present invention;

FIG. 7 shows an example of a schematic view, according to one embodiment of the present invention;

FIG. 8 shows an expanded version of the schematic view shown in FIG. 7, according to one embodiment of the present invention;

FIG. 9 shows an example of the image shown in FIG. 5, from a different viewing position, according to one embodiment of the present invention;

FIG. 10 shows a first schematic view highlighting selected nodes and links, according to one embodiment of the present invention;

FIG. 11 shows a first topologically transformed schematic view, according to one embodiment of the present invention;

FIG. 12 shows a second schematic view highlighting selected nodes and links, according to one embodiment of the present invention;

FIG. 13 shows a second topologically transformed schematic view, according to one embodiment of the present invention;

FIG. 14 shows a third schematic view highlighting selected nodes and links, according to one embodiment of the present invention;

FIG. 15 shows a third topologically transformed schematic view, according to one embodiment of the present invention;

FIG. 16 shows an example of the image shown in FIG. 5, from a different viewing position, according to one embodiment of the present invention;

FIG. 17 shows a fourth schematic view highlighting selected nodes and links, according to one embodiment of the present invention;

FIG. 18 shows a fourth topologically transformed schematic view, according to one embodiment of the present invention;

FIG. 19 shows a fifth schematic view highlighting selected nodes and links, according to one embodiment of the present invention;

FIG. 20 shows a fifth topologically transformed schematic view, according to one embodiment of the present invention;

FIG. 21 shows a sixth schematic view highlighting selected nodes and links, according to one embodiment of the present invention; and

FIG. 22 shows a sixth topologically transformed schematic view, according to one embodiment of the present invention.

### DETAILED DESCRIPTION

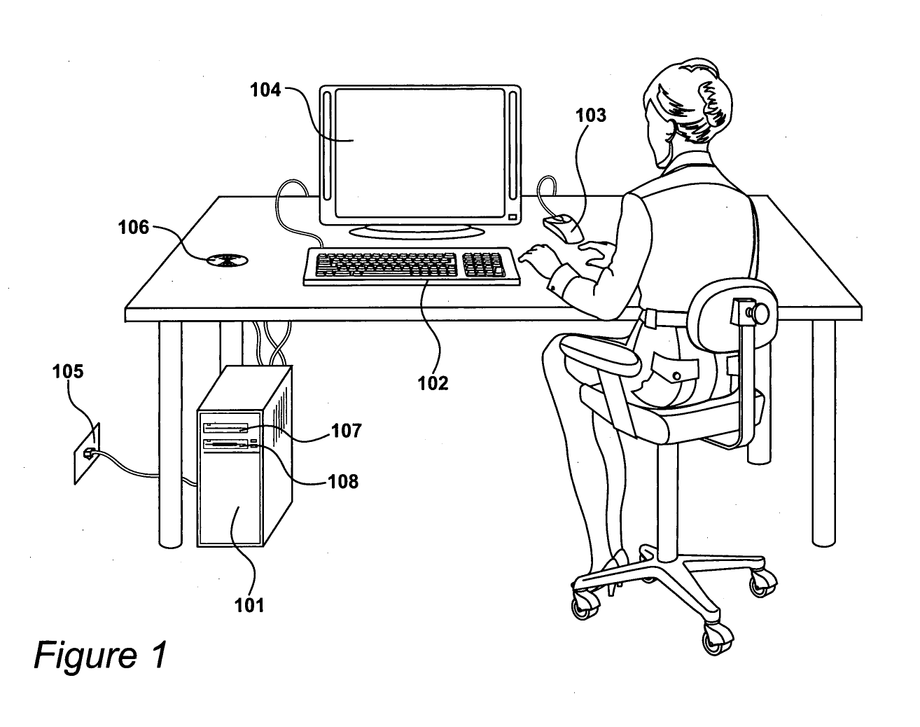

FIG. 1 shows an environment for representing a machine-readable definition of a three-dimensional object, according to one embodiment of the present invention. Data processing is effected by a programmable computer system 101 that responds to input data from a user via a keyboard 102 and a mouse 103. Alternatively, other input devices may be used such as a stylus and tablet or a tracker-ball. Output data from computer system 101 is displayed to the user via a visual display unit 104. A network connection 105 allows computer system 101 to communicate with a local server and also facilitates communication externally via the internet.

Computer system 101 receives input data from the keyboard 102 and other input devices via cable connections although in alternative embodiments radio interfaces could be provided. Many different types of programmable computer system 101 could be deployed and in alternative embodiments the functionality could be provided using dedicated hardware.

Instructions executable by computer system 101 are received by an instruction carrying medium such as a CD-ROM 106 or a similar instruction carrying medium such as a DVD etc. The computer system 101 may also have devices for recording output data, such as CD-ROM burners or DVD burner 107 or removable magnetic disk storage device 108, for example.

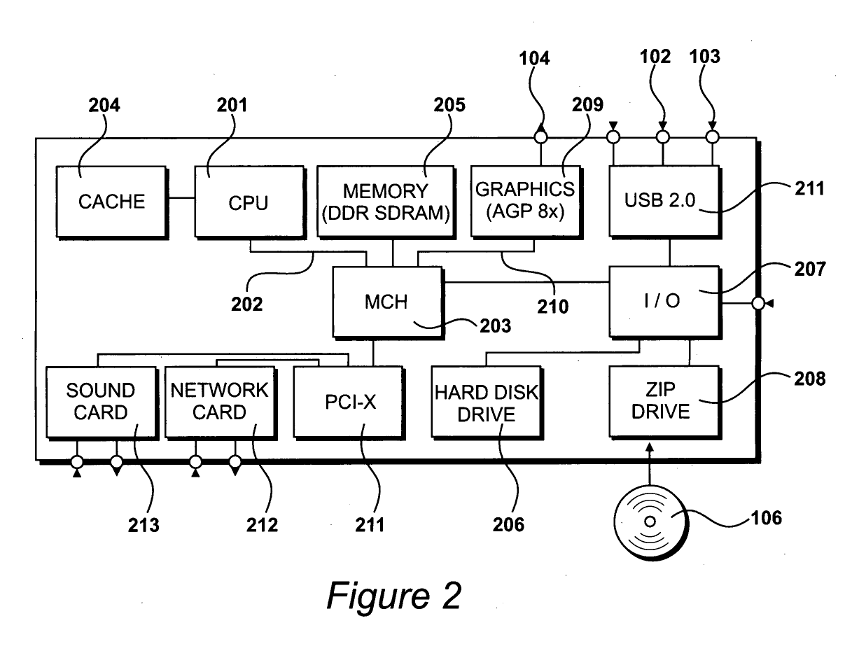

FIG. 2 shows the components of computer system 101, according to one embodiment of the present invention. In some embodiments of the present invention, the components are based upon Intel® E7505 hub-based Chipset.

The system includes an Intel® Pentium™ Xeon™ DP central processing unit (CPU) 201 running at three Gigahertz (3 GHz), which fetches instructions for execution and manipulates data via an Intel® E7505 533 Megahertz system bus 202 providing connectivity with a Memory Controller Hub (MCH) 203. The CPU 201 has a secondary cache 204 comprising five hundred and twelve kilobytes of high speed static RAM, for storing frequently-accessed instructions and data to reduce fetching operations from a larger main memory 205 via the memory controller hub 203. The memory controller hub 203 thus co-ordinates data and instruction flow with the main memory 205, which is one gigabyte in storage capacity. Instructions and data are thus stored in the main memory 205 and the cache 204 for swift access by the CPU 201.

A hard disk drive 206 provides non-volatile bulk storage of instructions and data via an Input/Output Controller Hub (ICH) 207. The I/O controller hub 207 similarly provides connectivity to DVD-ROM re-writer 208 which reads the CDROM 106 shown in FIG. 1. Connectivity is also provided to USB 2.0 interface 211, to which the keyboard 102 and mouse 103 are attached, all of which send user input data to the processing system 101.

A graphics card 209 receives graphic data and instructions from the CPU 201. The graphics card 209 is connected to the memory controller hub 203 by means of a high speed AGP graphics bus 210. A PCI interface 211 provides connections to a network card 212 that provides access to the network 106, over which instructions and or data may be transferred. A sound card 213 is also connected to the PCI interface 211 and receives sound data or instructions from the CPU 201.

The equipment shown in FIG. 2 constitutes the components of a high-end IBM™ PC compatible processing system. In an alternative embodiment of the present invention, similar functionality is achieved using an Apple™ PowerPC™ architecture-based processing system.

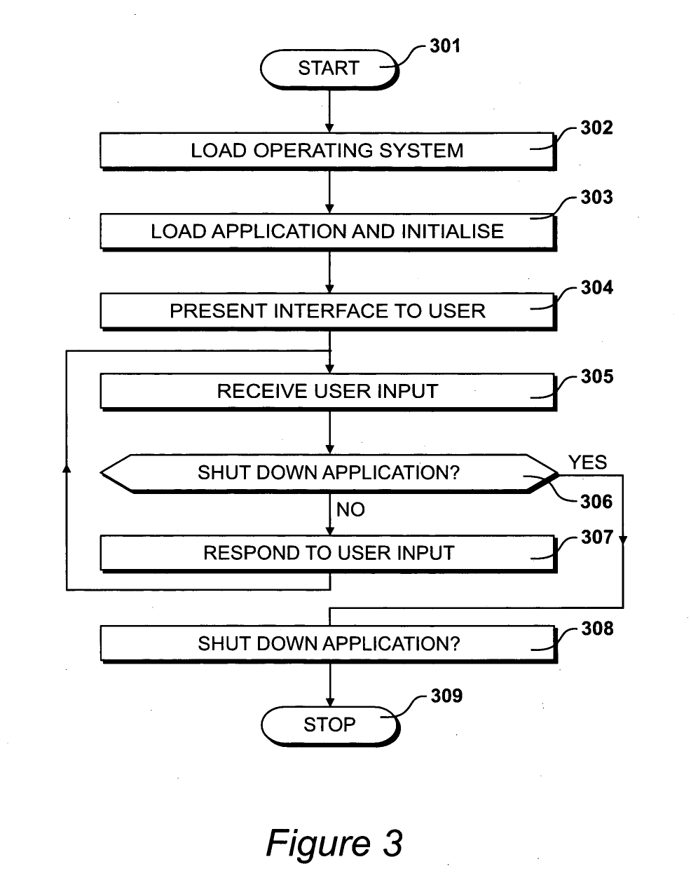

FIG. 3 shows operations performed by the system illustrated in Figure, according to one embodiment of the present invention. After starting operation at step 301, instructions defining an operating system are loaded at step 302. In an embodiment of the present invention, the operating system is Microsoft™ Windows™ but in alternative embodiments of the present invention other operating systems may be used such as MacX™, Unix™ or Linux™, for example.

At step 303 instructions for the application of an embodiment of the present invention are loaded and initialised resulting in a user interface being displayed at step 304.

At step 305 a user input command is received either in response to operation of a keyboard 102 or in response to operation of mouse 103.

At step 306 a question is asked as to whether a shutdown command has been received and if this question is answered in the affirmative the application is shut down at step 308 and the procedure is stopped 309. Alternatively, if the question asked at step 306 is answered in the negative, the application responds to the user input (received at step 305) at step 307. Thereafter, further input commands are received at step 305 and further responses are made at step 307 until a shutdown command is received and the question asked at step 306 is answered in the affirmative.

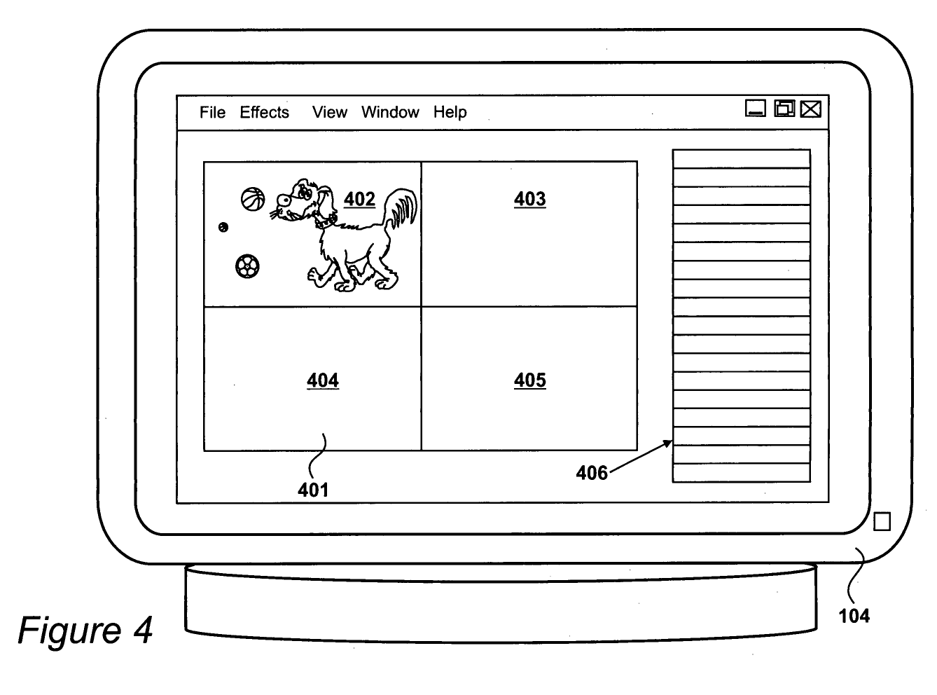

A user interface, generated at step 304 as previously described, is displayed to a user via visual display unit 104 as illustrated in FIG. 4, according to one embodiment of the present invention. A main display window 401 is divided into four tiles 402, 403, 404 and 405. Tile 402 displays a three-dimensional representation of an object or objects and orthogonal projections may be displayed in tiles 403 to 405. In addition, a window 406 displays a menu of functions that may be selected by cursor positioning in response to operation of mouse 103. Many functions are available within the system including functions for the generation and manipulation of schematic views as described with reference to the present embodiments.

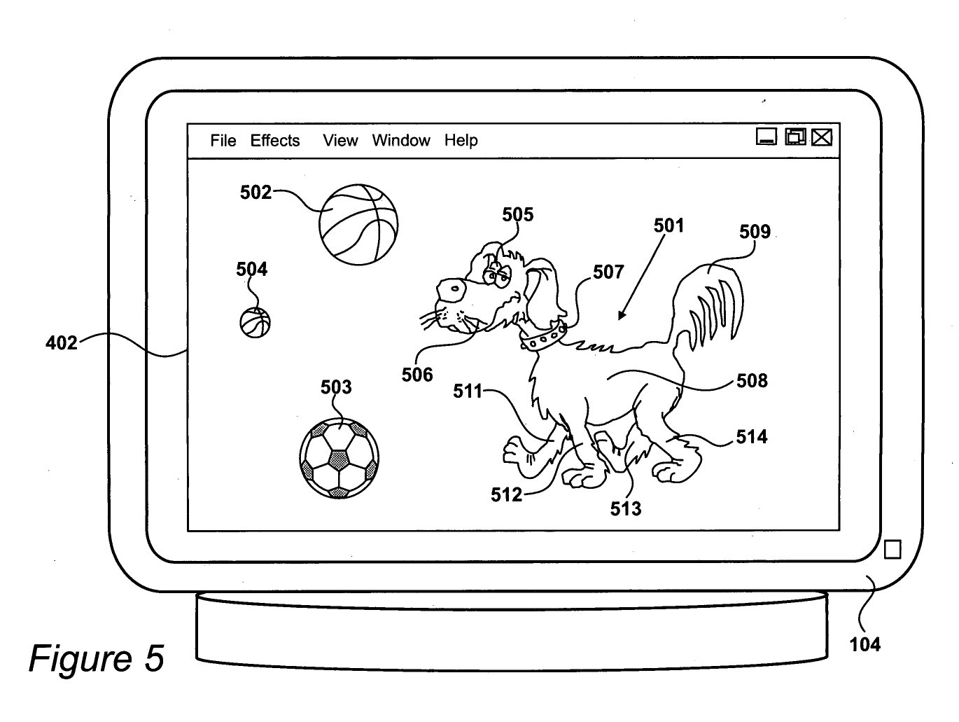

FIG. 5 shows Tile 402 and illustrates a three-dimensional scene that is currently being manipulated by a user, according to one embodiment of the present invention. In this example, described for the benefit of illustration only, the scene consists of an animatable dog 501 along with a first animatable ball 502, a second animatable ball 503 and a third animatable ball 504. Individual components of dog 501 may be animated independently. Thus, the dog's eyes 505 may be animated along with the dog's head 506 with respect to the dog's neck 507. Neck 507 may be animated with respect to the dog's body 508 and the dog's tail 509 may also be animated with respect to the dog's body 508. A first leg 511 may be animated with respect to the dog's body 508, a second leg 512 may be animated with respect to the dog's body, a third leg 513 may be animated with respect to the dog's body, and a fourth leg 514 may be animated with respect to the dog's body 508. Furthermore, each of said legs 511 to 514 consists of an upper portion, a lower portion and a foot.

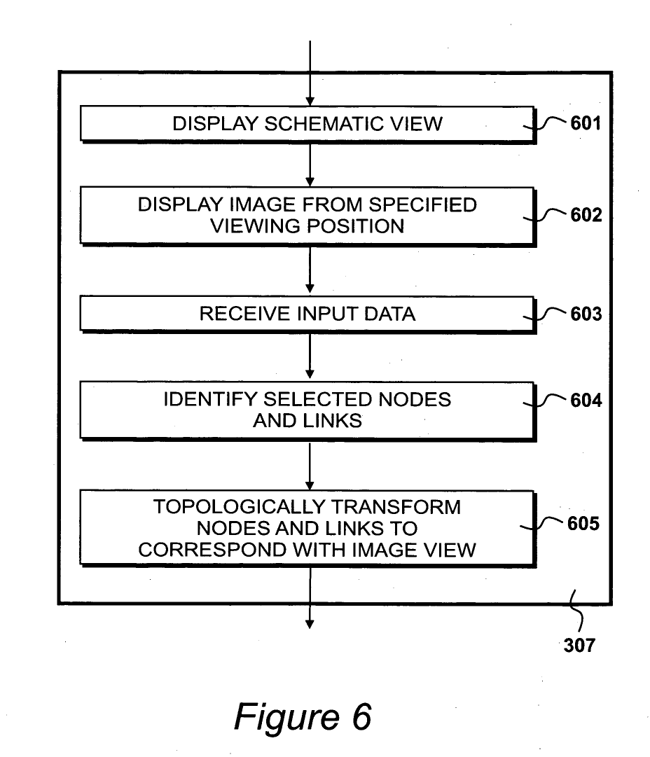

FIG. 6 shows procedures performed at step 307, relevant to an embodiment of the present invention. At step 601 a schematic view is displayed to a user on visual display unit 104.

At step 602 an image such as the one shown in FIG. 5 is displayed from a specified viewing position, as selected by the user. Input data is received at step 603, identifying elements of the image displayed at step 602.

At step 604, nodes and links which correspond to the elements selected at step 603 are identified in the schematic view displayed at step 601. A topological transformation is then performed at step 605 so that the relative positions of the nodes and links is substantially similar to the relative positions of their respective elements in the image displayed at step 602.

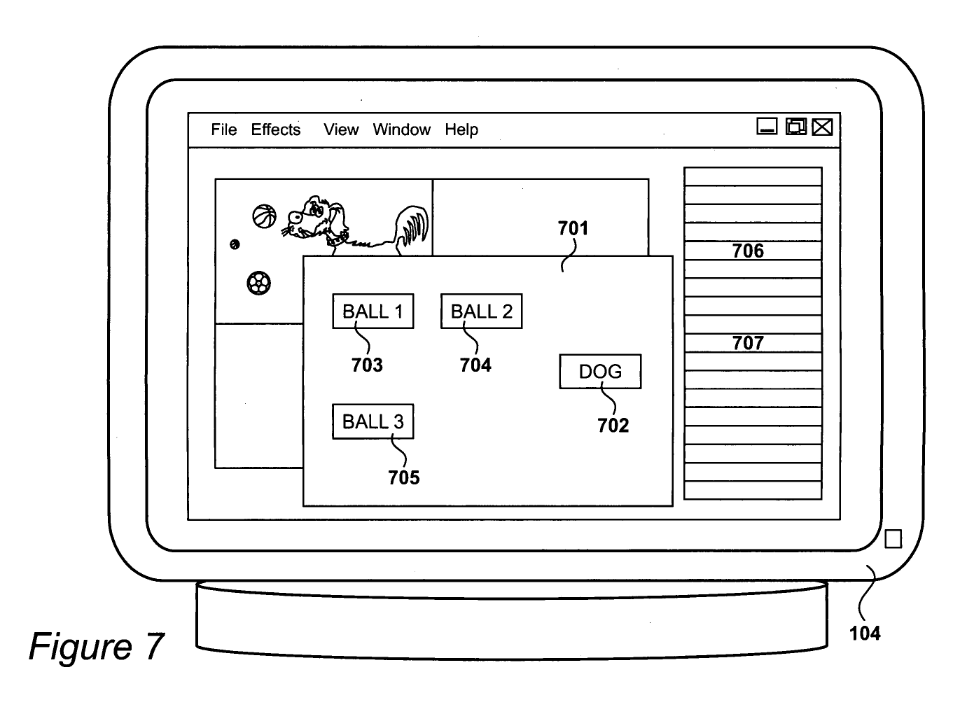

As previously stated, step 601 effects the display of a schematic view as shown in FIG. 7, according to one embodiment of the present invention. The schematic view is presented on visual display unit 104 in the form of a floating window 701. Each of the objects within the view is represented by a respective node. Such that the dog object 501 is represented by a dog node 702, ball object 502 is represented by ball 1 node 703, ball object 503 is represented by a ball 2 node 704 and ball object 504 is represented by a ball 3 node 705.

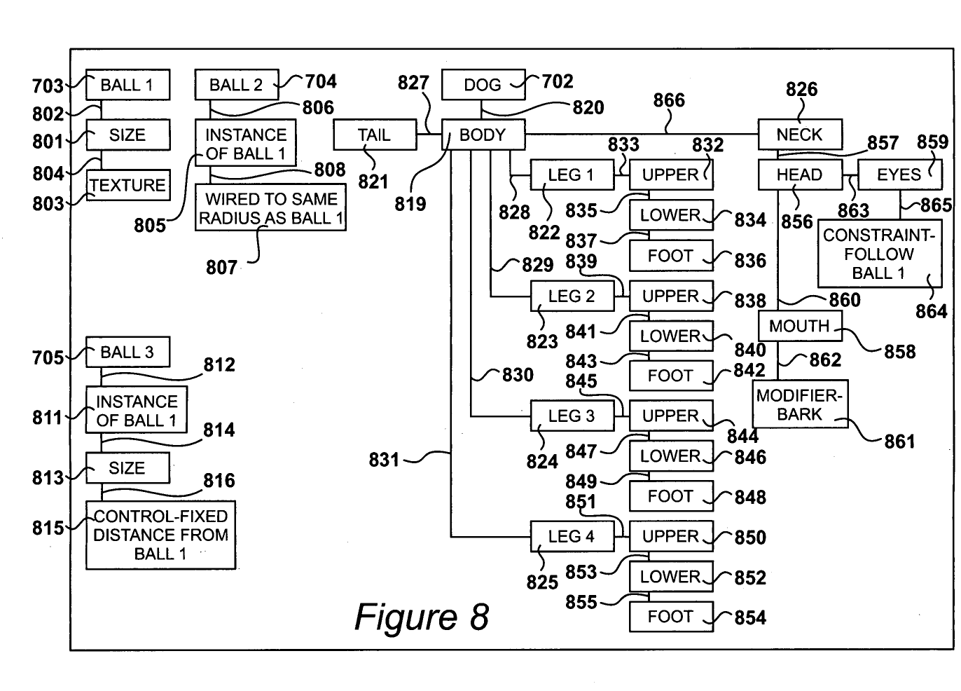

In response to operation of an appropriate menu function 706, the schematic view 701 is expanded to occupy the full screen of the visual display unit 104 and to display lower level related elements for each object as shown in FIG. 8.

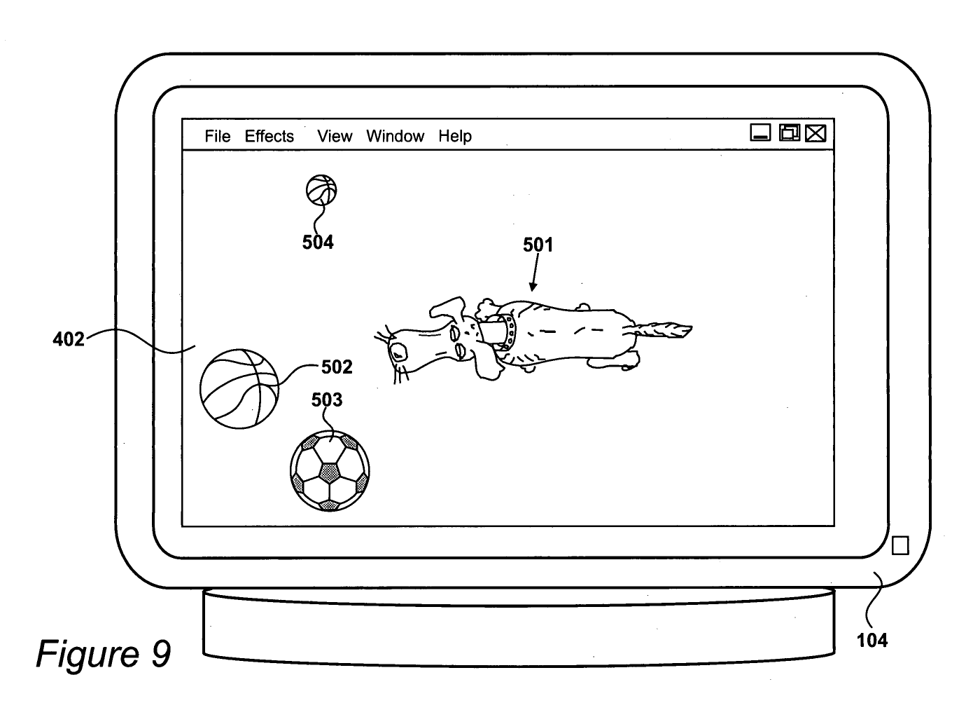

In response to operation of an appropriate menu function 707, the image is displayed from a specific viewing position as described at step 602. This is shown in FIG. 9.

FIG. 8 shows an expanded schematic view as effected by step 601 in which nodes 702, 703, 704 and 705 are present, according to one embodiment of the present invention. However, each of these objects has been constructed from a plurality of elements representing the topology of the object along with other attributes such as textures and inter-relationships. In the schematic view, as shown in FIG. 8, each of these elements is represented by a node and the relationships between the nodes (elements) are represented by links that, topologically speaking, may be considered as arcs.

Ball 1 object 703 includes a node 801 linked to the ball object 703 via a link 802. Node 801 relates to the sizing of ball 1 such that the size of ball 1 may be controlled independently in response to additional data defined by a user. Ball 1 also has a texture applied thereto as identified by texture node 803 connected to node 801 via a link 804.

Ball 2 object 704 includes a node 805 linked to the ball object 704 via a link 806. Node 805 represents the fact that ball 2 is an instance of ball 1. Ball 2 is also wired to have the same radius as ball 1 as identified by node 807 connected to node 805 via a link 808.

Ball 3 object 705 includes a node 811 connected to the ball object via a link 812. Node 811 illustrates that ball 3 is an instance of ball 1. Ball 3 also has a node 813 relating to its size which is connected to node 811 via a link 814. A further node, 815, represents the fact that ball 3 is configured to remain a fixed distance from ball 1. Node 815 is connected to node 813 via a link 816.

Dog object 702 includes a node 819 connected to the dog object via a link 820. Node 819 relates to the body of the dog. Nodes 821, 822, 823, 824, 825, and 826 are all connected to body node 819. Node 821 relates to the tail and is connected to body node 819 via a link 827.

Node 822 relates to a first leg and is connected to body node 819 via a link 828. Node 823 relates to a second leg and is connected to body node 819 via a link 829. Node 824 relates to a third leg and is connected to body node 819 via a link 830. Node 825 relates to a fourth leg and is connected to body node 819 via a link 831.

Leg 1 node 822 includes a node 832 connected to node 822 via a link 833. Node 832 refers to the upper portion of the first leg. A node 834 is connected to node 832 via a link 835 and relates to the lower portion of leg 1. Further, there is a foot node 836 which is connected to node 834 via a link 837.

Leg 2 node 823 includes a node 838 connected to node 823 via a link 839. Node 838 refers to the upper portion of the second leg. A further node 840 is connected to node 838 via a link 841 and relates to the lower portion of leg 2. Further, there is a foot node 842 which is connected to node 840 via a link 843.

Leg 3 node 824 includes a node 844 connected to node 824 via a link 845. Node 844 refers to the upper portion of the third leg. A node 846 is connected to node 844 via a link 847 and relates to the lower portion of leg 3. Further, there is a foot node 848 which is connected to node 846 via a link 849.

Leg 4 node 825 includes a node 850 connected to node 825 via a link 851. Node 850 refers to the upper portion of the fourth leg. A node 852 is connected to node 850 via a link 853 and relates to the lower portion of leg 4. Further, there is a foot node 854 which is connected to node 852 via a link 855.

Node 826 relates to the neck and is connected to body node 819 via a link 866. Neck node 826 includes a head node 856 connected to neck node 826 via a link 857. Mouth node 858 and eyes node 859 are connected to head node 856.

Mouth node 858 is connected to head node 856 via a link 860. A further node 861 represents the fact that a modifier is applied to the mouth which causes it to be animated when a barking sound is generated. Modifier node 861 is connected to mouth node 858 via a link 862.

Eyes node 859 is connected to head node 856 via a link 863. A further node 864 is connected to eyes node 859 via a link 865 and represents a constraint upon eyes node 859 that the eyes must follow the path of ball 1.

An example of the image shown in FIG. 5, from a different viewing position as specified at step 602 is shown in FIG. 9, according to one embodiment of the present invention. Here the view is from above. The image is displayed on visual display unit 104. Dog 501 can be seen here together with balls 502, 503 and 504. From this display the user is able to select one or more elements.

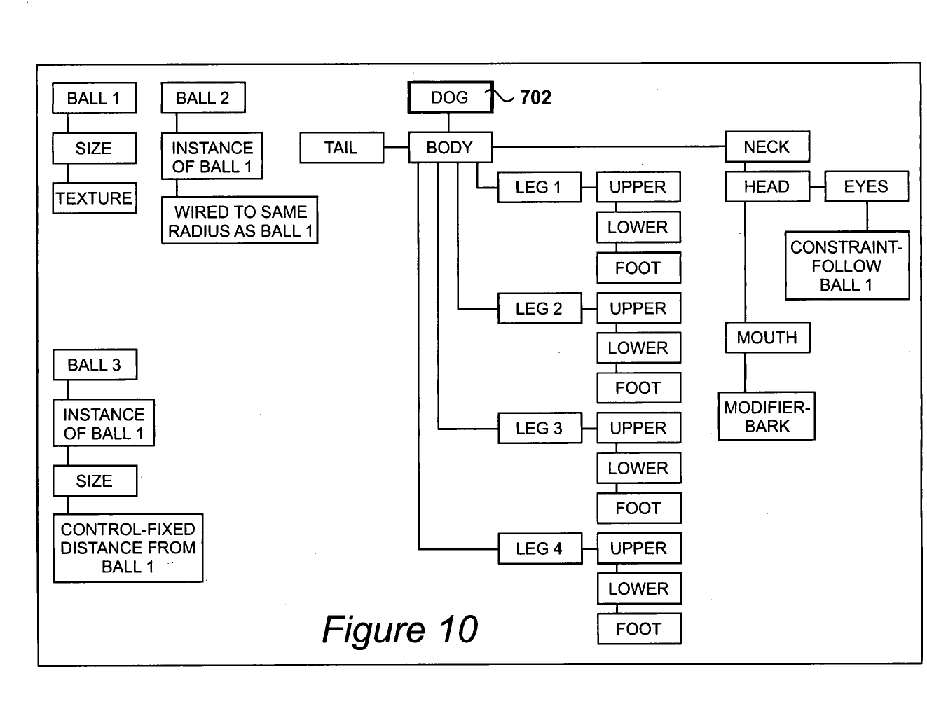

A modified schematic view is shown in FIG. 10. This view illustrates the identification of the dog node 702 at step 604, as a result of selection of the dog element 501 from the image displayed in FIG. 9 at step 603.

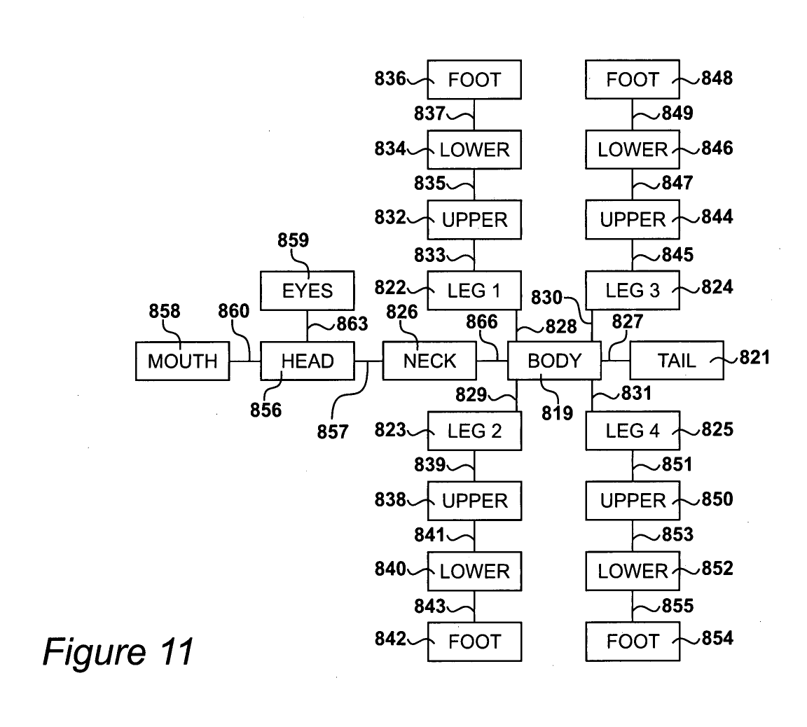

A topologically transformed schematic view is shown in FIG. 11, according to one embodiment of the present invention. This represents step 605 and shows the nodes and elements in a substantially similar position to the relative positions of their respective elements in the image view shown in FIG. 9. As the dog node 702 was identified at step 604, here all the nodes and links that form the dog are displayed. This representation in a modified layout can make specific elements more locatable for modification.

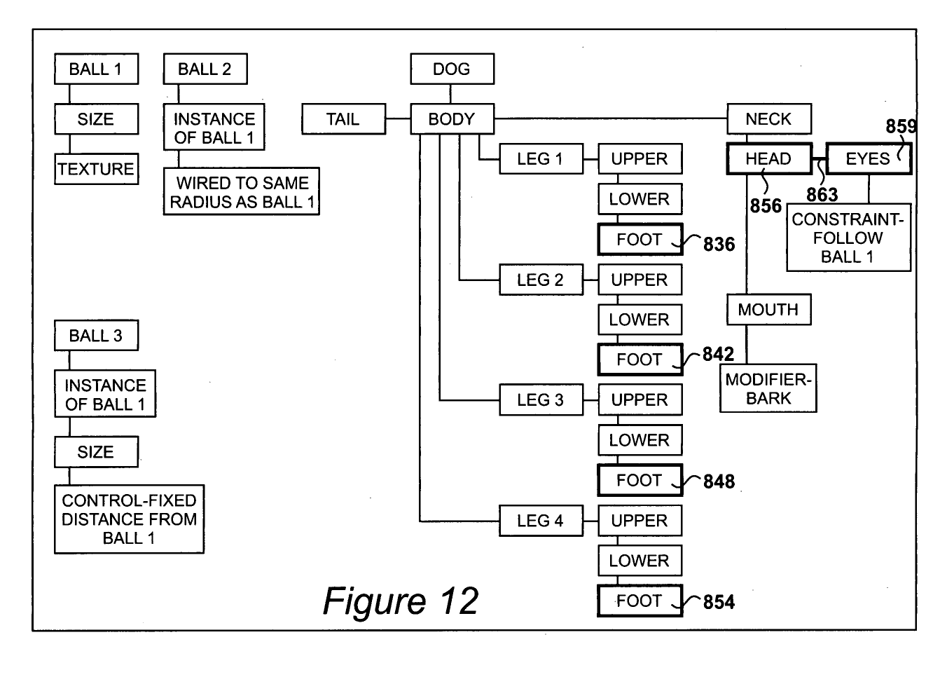

FIG. 12 shows a modified schematic view that would result from selection of the feet, head, and eyes at step 603, according to one embodiment of the present invention. The foot nodes 838, 842, 848 and 854, head node 856 and eyes node 859 are identified. The link 863 between head node 856 and eyes node 859 is also identified.

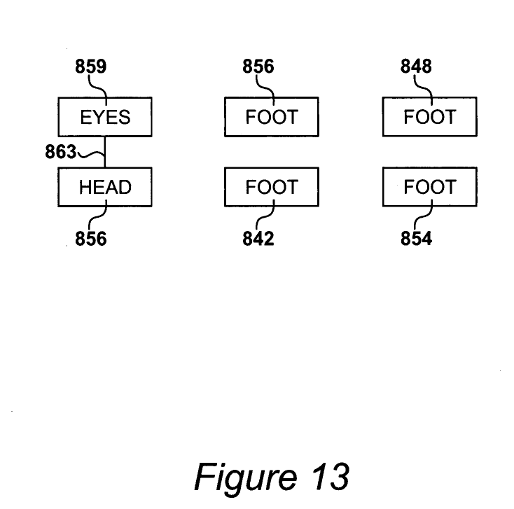

The modified schematic view in FIG. 13 follows on from the identification of nodes and links illustrated in FIG. 12, according to one embodiment of the present invention. The nodes identified at step 604 are shown in FIG. 13, topologically transformed so that the nodes and elements are in substantially similar positions to the relative positions of their respective elements in the image view shown in FIG. 9.

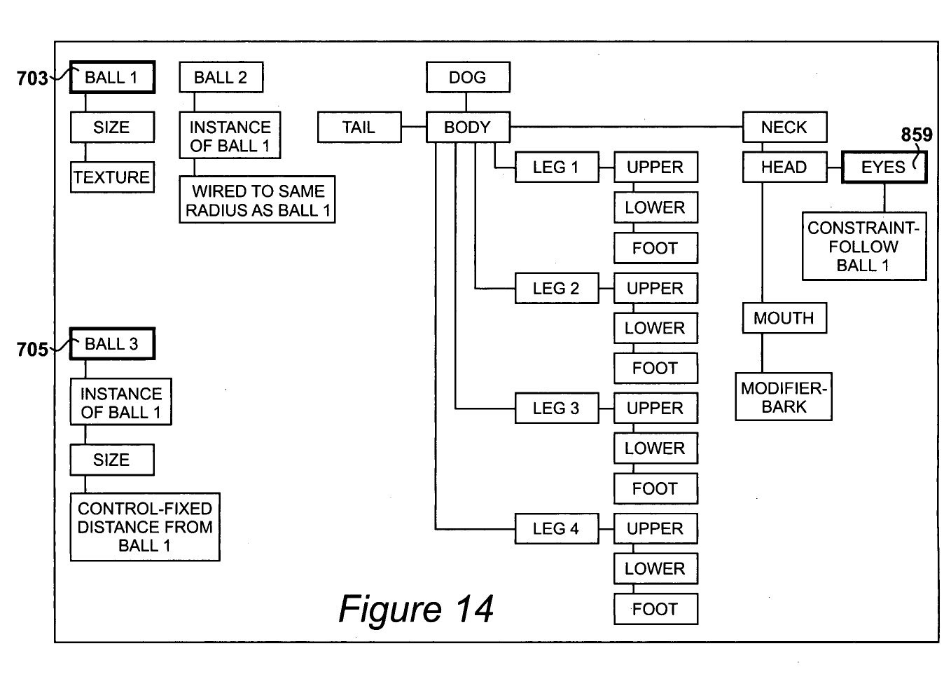

FIG. 14 shows a modified schematic view that would result from selection of ball 1, ball 3 and the eyes at step 603, according to one embodiment of the present invention. The ball 1 node 703, ball 3 node 705 and eyes node 859 are highlighted.

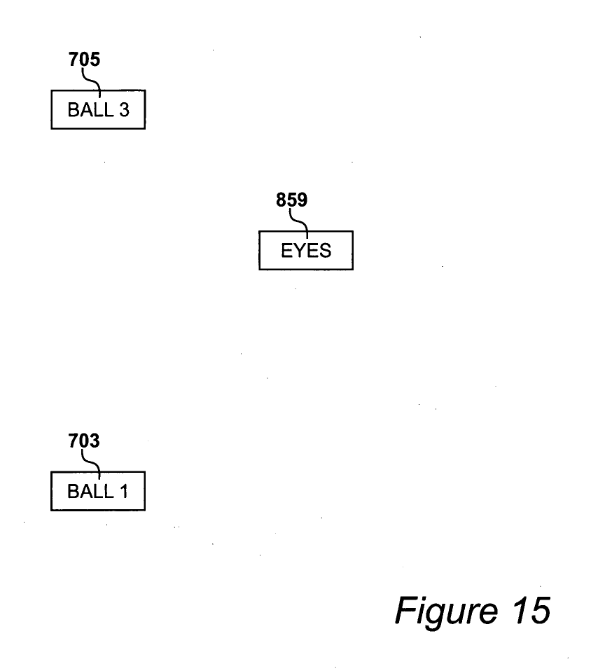

The modified schematic view in FIG. 15 follows on from the identification of nodes and links illustrated in FIG. 14, according to one embodiment of the present invention. The nodes identified at step 604 are shown in FIG. 15, topologically transformed so that the nodes and elements are in substantially similar positions to the relative positions of their respective elements in the image view shown in FIG. 9.

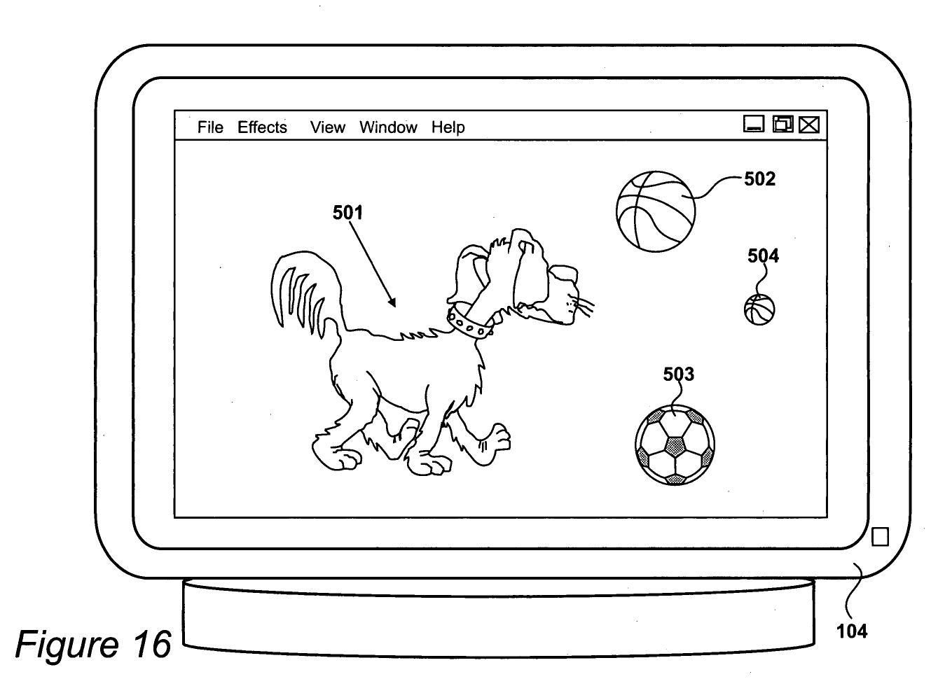

An example of the image shown in FIG. 5, from a different viewing position as specified at step 602 is shown in FIG. 16, according to one embodiment of the present invention. Here the view is from behind. The image is displayed on visual display unit 104. Dog 501 can be seen here together with balls 502, 503 and 504. From this display the user is able to select one or more elements.

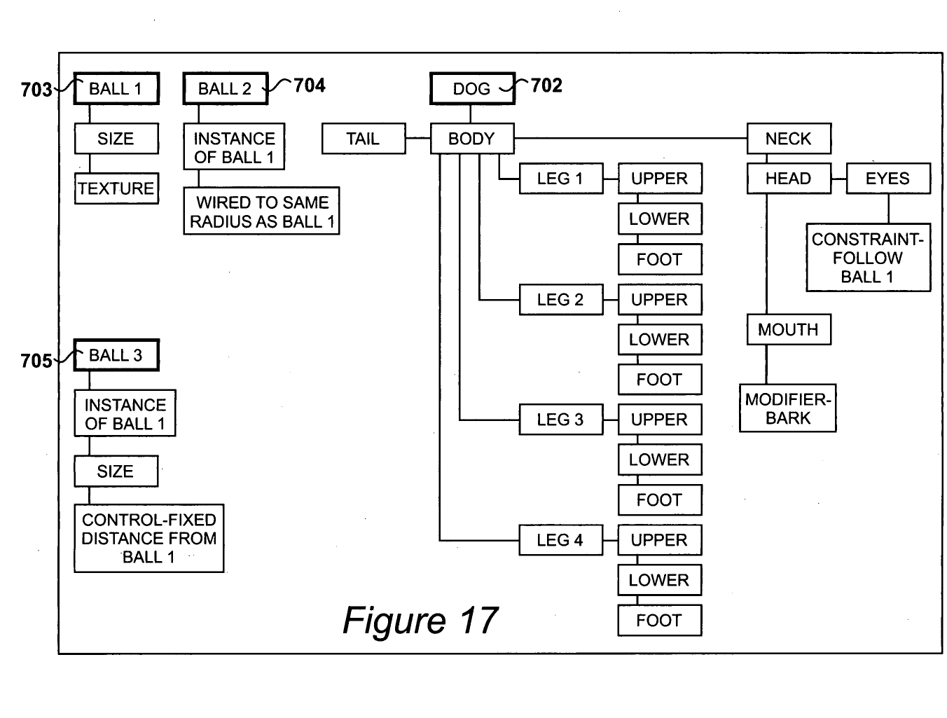

FIG. 17 shows a modified schematic view that would result from selection of all the elements: ball 1, ball 2, ball 3 and the dog at step 603, according to one embodiment of the present invention. The ball 1 node 703, ball 2 node 704, ball 3 node 705 and dog node 702 are highlighted.

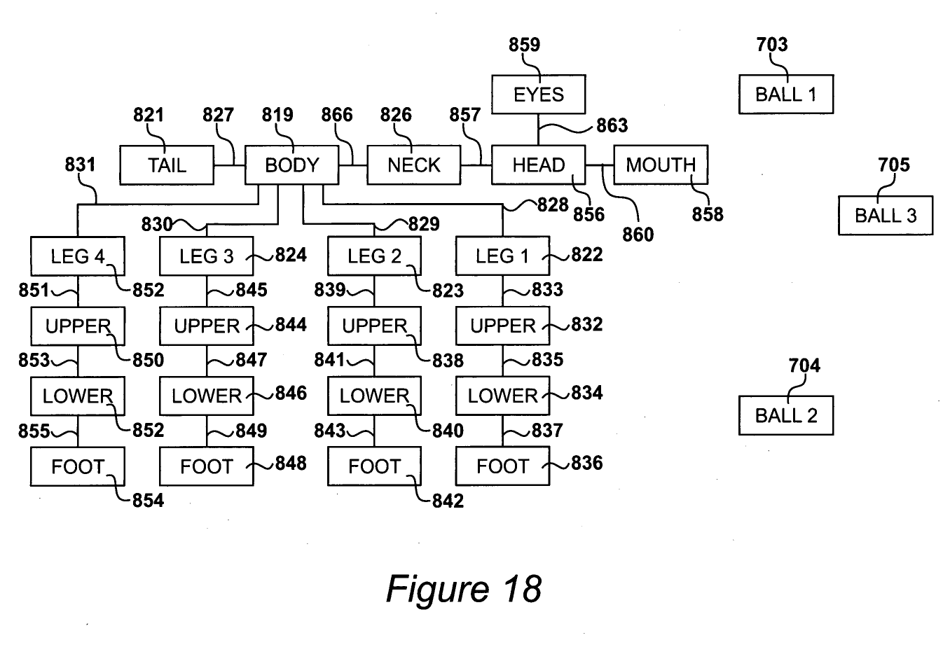

The modified schematic view in FIG. 18 follows on from the identification of nodes and links illustrated in FIG. 17, according to one embodiment of the present invention. The nodes identified at step 604 are shown in FIG. 18, topologically transformed so that the nodes and elements are in substantially similar positions to the relative positions of their respective elements in the image view shown in FIG. 16.

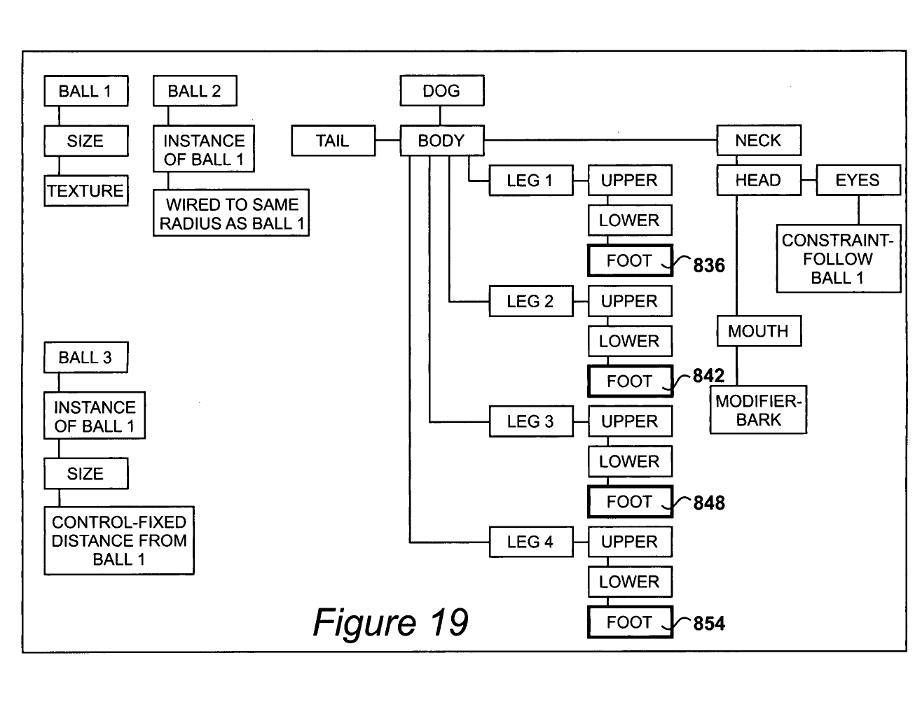

FIG. 19 shows a modified schematic view that would result from the selection of the four foot nodes at step 603, according to one embodiment of the present invention. Foot nodes 836, 842, 848 and 854 are highlighted.

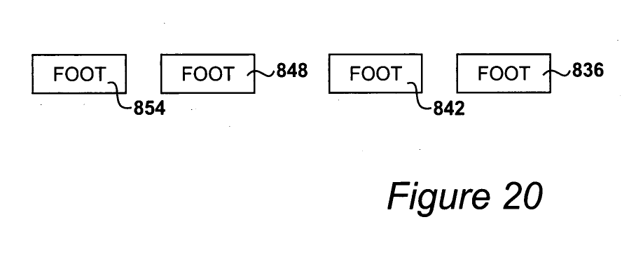

The modified schematic view in FIG. 20 follows on from the identification of nodes and links illustrated in FIG. 19, according to one embodiment of the present invention. The nodes identified at step 604 are shown in FIG. 20, topologically transformed so that the nodes and elements are in substantially similar positions to the relative positions of their respective elements in the image view shown in FIG. 16.

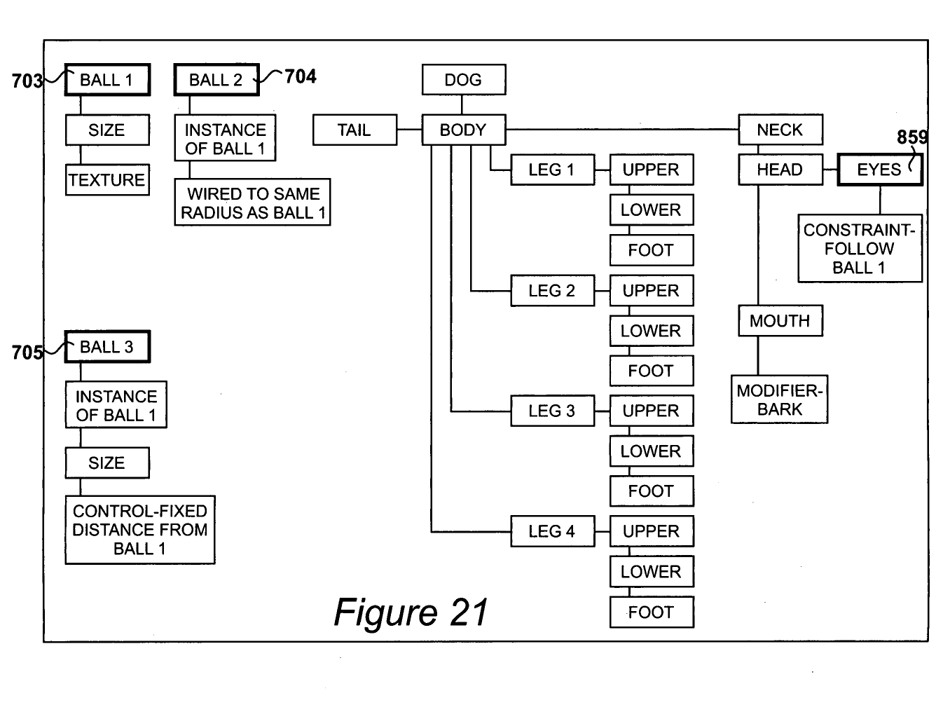

FIG. 21 shows a modified schematic view that would result from the selection of the three ball nodes and the eyes node, according to one embodiment of the present invention. Ball 1 node 703, ball 2 node 704, ball 3 node 705 and eyes node 859 are highlighted.

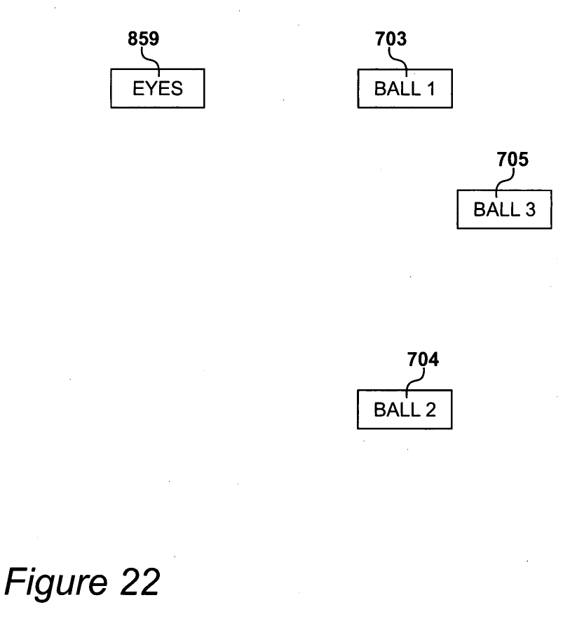

The modified schematic view in FIG. 22 follows on from the identification of nodes and links illustrated in FIG. 20, according to one embodiment of the present invention. The nodes identified at step 604 are shown in FIG. 22, topologically transformed so that the nodes and elements are in substantially similar positions to the relative positions of their respective elements in the image view shown in FIG. 16.

The invention has been described above with reference to specific embodiments. Persons skilled in the art will recognize, however, that various modifications and changes may be made thereto without departing from the broader spirit and scope of the invention as set forth in the appended claims. The foregoing description and drawings are, accordingly, to be regarded in an illustrative rather than a restrictive sense. The listing of steps in method claims do not imply performing the steps in any particular order, unless explicitly stated in the claim.

1. A computer readable medium storing instructions for causing a computer to display a modified schematic view of a scene including a three dimensional object, performing the steps of:
displaying an image view of the scene to produce a two-dimensional view from a specified viewing position;
receiving a first selection data input specifying a first element of the three-dimensional object, the first element represented by a first node;
topologically transforming the first node to produce a transformed first node, the transformed first node corresponding with a position of the first element in the image view; and
displaying the modified schematic view including the transformed first node.

2. The computer readable medium of claim 1, further comprising the step of identifying a second element of the three-dimensional object, the second element represented by a second node connected to the first node by a link.

3. The computer readable medium of claim 2, further comprising the steps of:
topologically transforming the second node and the link to produce a transformed second node and a transformed link, the transformed second node corresponding with a position of the second element in the image view; and
displaying the modified schematic view including the transformed second node and the transformed link.

4. The computer readable medium of claim 2, further comprising the step of displaying a schematic view of the scene including a highlighted representation of the first node, a highlighted representation of the second node, and a highlighted representation of the link.

5. The computer readable medium of claim 2, wherein the second node is below the first node in a hierarchy of a schematic view of the scene.

6. The computer readable medium of claim 1, further comprising the step of displaying a schematic view of the scene including a highlighted representation of the first node.

7. The computer readable medium of claim 1, further comprising the steps of:
receiving a second selection data input specifying a second element of the three-dimensional object, the second element represented by a second node;
topologically transforming the second node to produce a transformed second node, the transformed second node corresponding with a position of the second element in the image view; and
displaying the modified schematic view including the transformed second node.

8. The computer readable medium of claim 1, wherein the three-dimensional object is animatable.

9. A method for displaying a modified schematic view of a scene including a three dimensional object, comprising:
displaying an image view of the scene to produce a two-dimensional view from a specified viewing position;
receiving a first selection data input specifying a first element of the three-dimensional object, the first element represented by a first node;
topologically transforming the first node to produce a transformed first node, the transformed first node corresponding with a position of the first element in the image view; and
displaying the modified schematic view including the transformed first node.

10. The method of claim 9, further comprising the step of identifying a second element of the three-dimensional object, the second element represented by a second node connected to the first node by a link.

11. The method of claim 10, further comprising the steps of:
topologically transforming the second node and the link to produce a transformed second node and a transformed link, the transformed second node corresponding with a position of the second element in the image view; and
displaying the modified schematic view including the transformed second node and the transformed link.

12. The method of claim 10, further comprising the step of displaying a schematic view of the scene including a highlighted representation of the first node, a highlighted representation of the second node, and a highlighted representation of the link.

13. The method of claim 10, wherein the second node is below the first node in a hierarchy of the schematic view.

14. The method of claim 9, further comprising the step of displaying a schematic view of the scene including a highlighted representation of the first node.

15. The method of claim 9, further comprising the steps of:
receiving a second selection data input specifying a second element of the three-dimensional object, the second element represented by a second node;
topologically transforming the second node to produce a transformed second node, the transformed second node corresponding with a position of the second element in the image view; and
displaying the modified schematic view including the transformed second node.

17. A system for displaying a modified schematic view of a scene including a three dimensional object, the system comprising:
means for displaying an image view of the scene to produce a two-dimensional view from a specified viewing position;
means for receiving a first selection data input specifying a first element of the three-dimensional object, the first element represented by a first node;
means for topologically transforming the first node to produce a transformed first node, the transformed first node corresponding with a position of the first element in the image view; and
means for displaying the modified schematic view including the transformed first node.

18. The system of claim 17, further comprising means for identifying a second element of the three-dimensional object, the second element represented by a second node connected to the first node by a link.

19. The system of claim 18, further comprising:
means for topologically transforming the second node and the link to produce a transformed second node and a transformed link, the transformed second node corresponding with a position of the second element in the image view; and
means for displaying the modified schematic view including the transformed second node and the transformed link.

20. The system of claim 17, further comprising:
means for receiving a second selection data input specifying a second element of the three-dimensional object, the second element represented by a second node;
means for topologically transforming the second node to produce a transformed second node, the transformed second node corresponding with a position of the second element in the image view; and
means for displaying the modified schematic view including the transformed second node.
